(19) United States
(12) Patent Application Publication
(10) Pub. No.: US 2007/0243443 A1
(43) Pub. Date: Oct. 18, 2007

(54) Fuel Cell

(75) Inventors: Masahiko Iijima, Saitama-ken (JP); Shigeru Ogino, Aichi-ken (JP); Naoki Ito, Kanagawa-ken (JP); Satoshi Aoyama, Shizuoka-ken (JP); Satoshi Iguchi, Shizuoka-ken (JP); Kenji Kimura, Aichi-ken (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, AICHI (JP)

(21) Appl. No.: 10/590,881

(22) PCT Filed: Feb. 17, 2005
(86) PCT No.: PCT/JP05/02973

§ 371 Date: Sep. 26, 2006

(30) Foreign Application Priority Data
Mar. 4, 2004 (JP) 2004-060069

(51) Int. Cl. H01M 8/10

(52) U.S. Cl. 429/30

(57) ABSTRACT

A fuel cell having a single cell 20 comprises a hydrogen permeable metal layer 22 and a cathode 24 as layers equipped with catalytic metal for promoting a reaction of a labile substance supplied to the fuel cell during production of electricity in the fuel cell. Also, the fuel cell has an electrolyte layer 21 formed with a solid oxide. The electrolyte layer 21 has a high grain boundary density electrolyte layer 27, and low grain boundary density electrolyte layers 25 and 26 as decomposition reaction suppress parts to suppress a decomposition reaction of the solid oxide due to the catalyst metal.

### FIELD OF TECHNOLOGY

The invention relates to a fuel cell.

### BACKGROUND ART

Various types of fuel cells have been proposed in the past. For example, a construction for an electrolyte is known that forms a palladium metal membrane on a perovskite solid oxide layer that has proton conductivity.

In this manner, when a palladium metal membrane is formed on a solid oxide, it is possible for the decomposition reaction of the solid oxide to proceed due to metal such as the palladium disposed adjacent to the electrolyte layer. In further detail, the noble metal palladium functions as a catalyst to decompose the solid oxide, which is a complex oxide, and the proton conductivity of the solid oxide gradually drops due to the decomposition of the solid oxide, so there is the possibility that the performance of the fuel cell will drop. Such a problem is not limited to the above situation, but may also occur in cases where a metal layer is provided as an electrode on a solid oxide, for example, and is also common to situations where solid oxide and metal having activity for promoting the decomposition reaction of the solid oxide are disposed adjacent to each other.

### DISCLOSURE OF THE INVENTION

The present invention is intended to solve the conventional problem described above, and it is an object of the invention to prevent decomposition of the electrolyte layer due to metal adjacent thereto in a solid oxide-type fuel cell.

To achieve the object, a first fuel cell of the present invention is provided. The first fuel cell comprises a catalytic metal part equipped with catalytic metal for promoting a reaction of a reactive substance supplied to the fuel cell during the production of electricity in the fuel cell, and an electrolyte layer formed by a solid oxide, disposed adjacent to the catalytic metal part, and having a decomposition reaction suppress part for suppressing a decomposition reaction of the solid oxide due to the catalytic metal.

According to the first fuel cell of the present invention, the electrolyte layer has a decomposition reaction suppress part disposed adjacent to the catalytic metal part, so it is possible to suppress a decomposition reaction of the catalytic layer due to catalytic metal and prevent a drop in the fuel cell performance.

In the first fuel cell of the present invention, the decomposition reaction suppress part may be a region formed near the surface on the side of the electrolyte layer adjacent to the catalytic metal part, where the grain boundary density grain in the solid oxide of said region is lower than other regions in the electrolyte layer.

With such a construction, it is possible to suppress the progress of a decomposition reaction in the electrolyte layer by providing a region has lower grain boundary density and higher reactivity for receiving decomposition and other reactions than in crystal grains in the electrolyte layer near the surface on the side adjacent to the catalytic metal part.

Also, in the first fuel cell of the present invention, the decomposition reaction suppress part may be a region formed near the surface on the side of the electrolyte layer adjacent to the catalytic metal part, where said region is formed with a solid oxide whose decomposition reactivity for decomposing due to the catalytic metal is lower than other regions in the electrolyte layer.

With such a structure, it is possible to suppress the progress of a decomposition reaction in the electrolyte layer by forming a region near the surface on the side of the electrolyte layer adjacent to the catalytic metal part with solid oxide that has lower decomposition reactivity for decomposing due to catalytic metal than other regions.

In the first fuel cell of the present invention, the solid oxide for forming the decomposition reaction suppress part may have ion conductivity that is lower than the solid oxide for forming the other regions. In general, the lower the ion conductivity, the stronger the bonds that solid oxide has between atoms in crystal composing the solid oxide, so the decomposition reactivity decreases. Accordingly, a solid oxide with low ion conductivity may readily be used to form an electrolyte layer equipped with a decomposition reaction suppress part.

A second fuel cell of the present invention comprises an electrolyte layer made of solid oxide, a catalytic metal part equipped with catalytic metal for promoting a reaction of a reactive substance supplied to the fuel cell during the production of electricity in the fuel cell, and a decomposition reaction suppress part disposed between the electrolyte layer and the catalytic metal part for suppressing a decomposition reaction of the solid oxide due to the catalytic metal.

According to the second fuel cell of the present invention, there is a decomposition reaction suppress part for suppressing a decomposition reaction of solid oxide due to catalytic metal between the electrolyte layer and the catalytic metal part, so decomposition of the electrolyte layer in the fuel cell can be suppressed, preventing a drop in the fuel cell performance.

In the second fuel cell of the present invention, the decomposition reaction suppress part may be constructed with a decomposition-resistant material that has ion conductivity for allowing ions of the same conductive type to pass through the electrolyte layer and that has lower decomposition reactivity for decomposition due to the catalytic metal than the solid oxide.

With such a structure, a decomposition-resistant material is provided between the electrolyte layer and the catalytic metal part, so decomposition of the electrolyte layer can be suppressed, preventing a drop in the fuel cell performance.

Also, in the second fuel cell of the present invention, the decomposition reaction suppress part may be constructed with a low decomposition material that has ion conductivity for allowing ions of the same conductive type to pass through the electrolyte layer and that has lower activity for decomposing the solid oxide than the catalytic metal.

According to such a structure, a low decomposition material is provided between the electrolyte layer and the catalytic metal part, so it is possible to suppress decomposition of the electrolyte layer, preventing a drop in the fuel cell performance. The low decomposition material may also have conductivity.

In such a second fuel cell of the present invention, the decomposition reaction suppress part may be formed in a layer form such that the electrolyte layer surface is covered by the decomposition material or the low decomposition-resistant material, and the catalytic material part may be disposed on the decomposition reaction suppress part.

In such a case, it is possible to suppress decomposition of the electrolyte layer with a decomposition reaction suppress part formed in a layer form to cover the electrolyte layer surface.

Alternatively, in such a second fuel cell of the present invention, the catalytic metal part may be formed by catalytic metal dispersed in a support formation on the electrolyte layer in a granular state, and the decomposition reaction suppress part may be formed by the decomposition-resistant material or the low decomposition material for covering a part of the granular surface of the catalytic material such as to be interposed between the catalytic metal grains and the electrolyte layer.

In such a case, it is possible to suppress decomposition of the electrolyte layer with a reaction suppress part covering a part of the catalytic metal granular surface.

In the first and second fuel cells of the present invention, the solid oxide may have proton conductivity, the catalytic metal may be a hydrogen permeable metal, and the catalytic metal part may be a fine hydrogen permeable metal layer for covering the decomposition suppress part disposed on the electrolyte layer.

In such a case, it is possible to suppress decomposition of the electrolyte layer due to hydrogen permeable metal in the fuel cell formed by an electrolyte layer having proton conductivity on the hydrogen permeable metal layer.

The present invention may be implemented with a variety of modes in addition to those mentioned above; for example, it is possible to realize the present invention in modes such as a manufacturing method for a fuel cell, a degradation prevention method of a fuel cell.

### BRIEF DESCRIPTION OF THE DRAWINGS

FIG. 1 is a cross-section schematic view showing the construction of a single cell in outline.

FIG. 2 is an explanatory view representing a construction of an electrolyte layer.

FIG. 3 is an explanatory view representing a construction of an electrolyte layer.

FIG. 4 is an explanatory view representing a construction of the fuel cell of the third embodiment.

FIG. 5 is an explanatory view representing a construction of the cathode in the fuel cell of the fourth embodiment.

FIG. 6 is an explanatory view showing the manufacturing process for forming a cathode.

FIG. 7 is an explanatory view representing a construction of the cathode in the fuel cell of the fifth embodiment.

FIG. 8 is an explanatory view representing a construction of the fuel cell in a variant of the fifth embodiment.

FIG. 9 is an explanatory view representing a construction of the fuel cell in a variant of the fifth embodiment.

### BEST MODES OF CARRYING OUT THE INVENTION

Modes for working the present invention are described below based on embodiments.

### A. First Embodiment

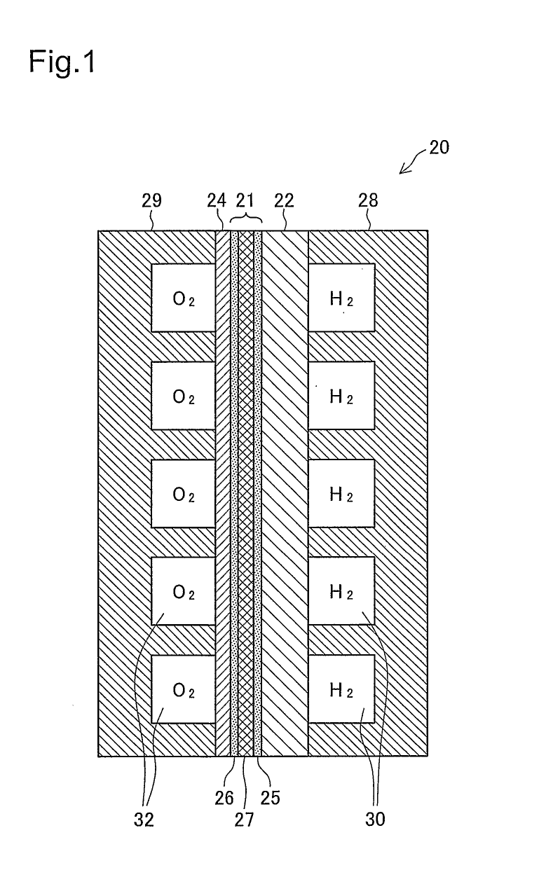

A description is given in outline of the structure of a single cell 20 that composes the fuel cell of the present embodiment with reference to FIG. 1. FIG. 1 is a cross-section schematic view showing the outline structure of the single cell 20 composing the fuel cell of the present embodiment. The single cell 20 has a layer construction made from a hydrogen permeable metal layer 22, an electrolyte layer 21 formed on a surface of the hydrogen permeable metal layer 22, and a cathode 24 formed on the electrolyte layer 21. Also, the layer structure of the single cell 20 has two gas separators 28 and 29 held by both sides. A single cell-internal fuel gas channel 30 through which fuel gas containing hydrogen passes is formed between the gas separator 28 and the hydrogen permeable metal layer 22. Also, a single cell-internal oxide gas channel 32 through which oxide gas containing oxygen passes is formed between the gas separator 29 and the cathode 24.

The hydrogen permeable metal layer 22 is a dense layer formed with metal having hydrogen permeability. For example, the layer may be formed with palladium (Pd) or a Pd alloy. Also, a multiple-layer membrane formed with group V metals such as vanadium (V) (in addition to vanadium are niobium, tantalum, and the like) or an alloy thereof as the base and Pd or a Pd alloy layer on at least one of the surfaces thereof (the surface of the single cell-internal fuel gas channel) is acceptable. The hydrogen permeable metal layer 22 functions as an anode electrode in the fuel cell of the present invention.

The electrode layer 21 is made from a solid oxide having proton conductivity. A perovskite-type ceramic proton conductor such as, for example, a BaCeO₃ or SrCeO₃ type may be used as the solid electrolyte composing the electrolyte layer. The electrolyte layer 21 can be formed by producing the solid oxide on the hydrogen permeable metal layer 22. In this manner, the electrolyte layer 21 is formed as a membrane on the fine hydrogen permeable metal layer 22, making it possible to form an adequately thin electrolyte layer 21 membrane. By forming a thin electrolyte layer 21 membrane, the resistance thereof can be decreased, and it is possible to operate the fuel cell at approximately 200 to 600° C., a lower temperature than the operating temperature of conventional solid electrolyte-type fuel cells. The thickness of the electrolyte layer 21 can be, for example, between 0.1 and 5 μm.

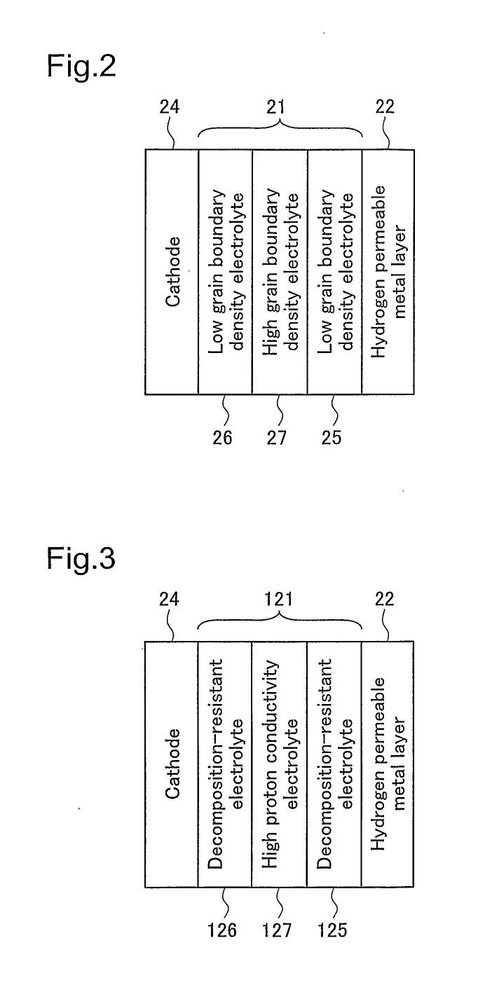

The construction of the electrolyte layer 21 is next described in detail with reference to FIG. 2. FIG. 2 is an explanatory view representing the structure of the electrolyte layer 21. The electrolyte layer 21 of the present embodiment is formed by a solid oxide having a crystalline structure. As shown in FIG. 2, the electrolyte layer 21 has a three-layer structure comprising a low grain boundary density electrolyte layer 25 adjacent to the hydrogen permeable metal layer 22, a low grain density boundary electrolyte layer 26 adjacent to the cathode 24, and a high grain boundary density electrolyte layer 27 positioned therebetween. The low gain boundary density electrolyte layers 25 and 26 are formed with the crystal grain diameter of the solid oxide larger than that of the high grain boundary density electrolyte 27. In further detail, the density of the grain boundary of the solid oxide composing the electrolyte layer is lower than that of the high grain boundary electrolyte layer 27. The present embodiment is characterized by the fact that decomposition of the electrolyte layer 21 due to the catalytic metal composing the hydrogen permeable metal layer 22 and the cathode 24 is prevented by providing the low grain boundary density electrolyte layers 25 and 26 in the electrolyte layer 21.

Such an electrolyte layer 21 can be formed by physical vapor deposition (PVD), for example. To form the low grain boundary density electrolyte layer 25 on the hydrogen permeable metal layer 22, the temperature of the hydrogen permeable metal layer 22 comprising the substrate and the energy used when the solid oxide collides with the substrate are adjusted to provide adequate crystallization energy during membrane formation so the crystal grains grow to the desired size. To form the high grain boundary density electrolyte layer 27 on the low grain boundary density electrolyte layer 25, the temperature of the substrate (the hydrogen permeable metal layer 22 on whose surface the low grain boundary density electrolyte layer 25 was formed) and the energy used when the solid oxide collides with the substrate are adjusted to decrease the crystallization energy during membrane formation so the crystal grain diameter grows to a smaller size than the low grain boundary density electrolyte layer 25. To form the low grain boundary density electrolyte layer 26 on the high grain boundary density electrolyte layer 27, the energy used when the solid oxide collides with the substrate is adjusted to increase the crystallization energy during membrane formation so the membrane grows with the crystal grain diameter larger than the high grain boundary density electrolyte layer 27. Alternatively, after a solid oxide layer is formed on the high grain boundary density electrolyte layer 27, the formed solid oxide layer can be heated with, for example, laser annealing, to increase the crystal grain diameter, and the low grain boundary density electrolyte layer 26 formed. Through such a process, it is possible to form an electrolyte layer 21 having a three-layer structure. The electrolyte layer 21 may be formed using a method other than PVD as long as a three-layer structure is formed in which a high grain boundary density electrolyte layer is disposed between two low grain boundary density electrolyte layers. For example, the low grain boundary density electrolyte layers 25 and 26 may be formed by increasing the crystal grain diameter using a method where the diameter of the grains are larger when the solid oxide material is discharged toward the substrate. Methods for increasing the grain diameter over PVD when the material is discharged to the substrate include, for example, arc ion plating for producing clusters with a variety of sizes including droplets, and cluster beam deposition. Also, by adjusting the conditions of the method during membrane formation such as the applied voltage, it is possible to further control the grain diameter during membrane formation. The thickness of the low grain boundary density electrolyte layer 26 and the low grain boundary density electrolyte layer 25 may be, for example, between 0.05 and 0.1 μm.

The cathode 24 is a layer equipped with a catalytic metal having catalytic activity for promoting electrochemical reactions. In the present embodiment, the cathode 24 is provided by forming a Pt layer, which is a noble metal, on the electrolyte layer 21. The cathode electrolyte 24 of the present embodiment does not completely cover the electrolyte layer 21 as a dense metal membrane, but is formed adequately thin throughout so as to be porous. In this manner, the cathode 24 is made porous, thereby ensuring a three-phase boundary with the cathode 24. The cathode 24 may be formed with a PVD, chemical vapor deposition (CVD), or plating method, for example.

Although not given in FIG. 1, a current collecting part having conductivity and gas permeability may also be provided between the hydrogen permeable metal layer 22 and the gas separator 28 and/or between the cathode 24 and the gas separator 29. The current collector part may be formed with a porous foam metal or metal mesh substrate, a carbon cloth or carbon paper, a conductive ceramic, or the like, for example. It is desirable to form the current collector part from the same type of material as the gas separator 28 and 29 adjacent to the current collector part.

The gas separators 28 and 29 are gas impermeable plate members formed with conductive material such as carbon or metal. As shown in FIG. 1, the surface of each of the gas separators 28 and 29 is formed into prescribed contour shapes for forming the single cell-internal fuel gas channel 30 and the single cell-internal oxide gas channel 32. In the fuel cell of the present embodiment, there is actually no differentiation between the gas separators 28 and 29. In the surface of one of the gas separators, the single cell-internal fuel gas channel 30 of the prescribed single cell 20 is formed as the gas separator 28, and in the other surface, a single cell-internal oxide gas channel 32 of the single cell adjacent to the prescribed single cell 20 is formed as the gas separator 29. Also, a cooling medium channel may be provided between the neighboring single cells 20 in the fuel cell.

When the fuel cell generates electricity, hydrogen molecules in the fuel gas supplied to the single cell-internal fuel gas channel 30 separate into hydrogen atoms and protons due to the function of the hydrogen permeable metal, which is a catalytic metal, on the surface of the hydrogen permeable metal layer 22. The separated hydrogen atoms and protons pass through the hydrogen permeable metal layer 22, and then pass through the electrolyte layer 21 in a proton state. At this time, water is generated in the cathode 24 from protons that pass through the electrolyte layer 21 and reach the cathode 24 through the action of the catalytic metal (Pt) composing the cathode 24 and oxygen in the oxide gas supplied to the single cell-internal oxide gas channel 32, and the electrochemical reaction proceeds.

According to the fuel cell of first embodiment with the structure as described above, low grain boundary density electrolyte layers are formed near the surfaces of the electrolyte layer 21 (from the surface spanning a prescribed thickness), so decomposition of the electrolyte layer 21 can be suppressed, preventing a drop in performance of the fuel cell. The solid oxide composing the electrolyte layer 21 may potentially decompose gradually due to the Pd or other such metal composing the hydrogen permeable metal layer 22 and the Pt or other catalytic metal composing the cathode 24 acting as catalysts. The reactivity with which reactions such as decomposition proceed is generally significantly higher with a crystal grain boundary composing the solid oxide than in crystal grains. In the present embodiment, a layer with such a low grain boundary density is provided on the side adjacent to the catalytic metal in the electrolyte layer 21, providing a condition with few sites for a decomposition reaction in the region within the electrolyte layer 21 that might be affected by catalytic metal, suppressing the progress of the decomposition reaction in the electrolyte layer 21. In further detail, in the present embodiment, the low grain boundary density electrolyte layers 25 and 26 provided in the electrolyte layer 21 act as decomposition reaction suppress parts to suppress decomposition of the electrolyte layer 21. Also, in general, solid oxide has a property where the larger the crystal grain diameter, the more its strength drops, but in the present embodiment, the high grain boundary density electrolyte layer 27 is provided between the low grain boundary density electrolyte layers 25 and 26, so it is possible to ensure the strength of the entire electrolyte layer 21. When forming the electrolyte layer 21, the thickness of each of the low grain boundary density electrolyte layers 25 and 26 and of the high grain boundary density electrolyte layer 27 (the ratio to the overall thickness of the electrolyte layer 21) may be arbitrarily set taking into account effects of hindering decomposition of the electrolyte layer 21 by providing the low grain boundary density electrolyte layers 25 and 26 and the balance with the strength of the overall electrolyte layer 21.

The low grain boundary density electrolyte layers 25 and 26 and the high grain boundary density electrolyte layer 27 may be constructed such that the grain diameter of the solid oxide composing each layer is formed relatively uniform in each layer and that the average grain diameter differs in each layer of the whole, or constructed such that the grain diameter is not uniform with a layer. An example of a construction in which the grain diameter is not uniform within a layer is one where the grain diameters of the crystal in the low grain boundary density electrolyte layers 25 and 26 becomes larger as they get closer to the contact surface of the adjacent metal layer (the hydrogen permeable metal layer 22 or the cathode 24). Alternatively, it is possible to increase the ratio of large crystal grain diameters in the low grain boundary density electrolyte layers 25 and 26 as they get closer to the contact surface of the adjacent metal layer (the hydrogen permeable metal layer 22 or the cathode 24). In either case, the grain diameter density of the solid oxide composing the electrolyte layer 21 decreases near the region adjacent to the metal layer having activity that decomposes the solid oxide composing the electrolyte layer 21, so similar effects are obtained.

### B. Second Embodiment

In first embodiment, a decomposition reaction suppress part that is a region with a lower grain boundary density than other regions was provided near the surface adjacent to the hydrogen permeable metal layer 22 and the cathode 24 in the electrolyte layer 21, but a decomposition reaction suppress part may be formed with a solid oxide of a different type than that of other regions. Such a construction is described below as the second embodiment.

The structure of an electrolyte layer 121 provided in a fuel cell of the second embodiment is described with reference to FIG. 3. FIG. 3 is an explanatory view representing the construction of the electrolyte layer 121 provided in the fuel cell of Embodiment 2. Other than being equipped with the electrolyte layer 121 instead of the electrolyte layer 21, the fuel cell of the second embodiment has a construction similar to that in First embodiment, so parts in common are provided with the same reference numerals, and a detailed description is omitted. As with FIG. 2, FIG. 3 shows only the hydrogen permeable metal layer 22, the cathode 24, and the layers disposed therebetween.

As shown in FIG. 3, the electrolyte layer 121 has a three-layer structure equipped with a decomposition-resistant electrolyte layer 125 adjacent to the hydrogen permeable metal layer 22, a decomposition-resistant electrolyte layer 126 adjacent to the cathode 24, and a highly proton conductive electrolyte layer 127 positioned between the other two layers. In the present embodiment, the highly proton conductive electrolyte layer 127 is formed with a BaCeO₃ solid oxide. Also, the decomposition-resistant electrolyte layers 125 and 126 are constructed with a solid oxide that is a decomposition-resistant material with higher chemical stability than the BaCeO₃ solid oxide. The decomposition-resistant material composing the decomposition-resistant electrolyte layers 125 and 126 may be selected from a ceramic proton conductor such as SrZrO₃, CaZrO₃, CeO₂, Al₂O₃ or zeolite, for example. The electrolyte layer 121 may be formed by successively forming the decomposition-resistant electrolyte layer 125, the highly proton conductive electrolyte layer 127, and the decomposition-resistant electrolyte layer 126 on the hydrogen permeable metal layer 22 using PVD, CVD or another such method.

According to the fuel cell of the second embodiment constructed as described above, a decomposition-resistant electrolyte layer with a high chemical stability is formed on both sides of the electrolyte layer 121, so decomposition of the electrolyte layer 121 can be suppressed, preventing a drop in performance of the fuel cell. Solid oxides having proton conductivity generally have weaker bonds between atoms in the crystal composing the solid oxide the higher the proton conductivity. Accordingly, the higher the proton conductivity in a solid oxide, the more readily the solid oxide decomposes due to the effect of the catalytic metal. In the present embodiment, a layer made from a solid oxide with high chemical stability and relatively weak bonds between atoms is provided on the side adjacent to the hydrogen permeable metal layer 22 and the cathode 24, suppressing progress of the decomposition reaction in the electrolyte layer 121. In further detail, in the present embodiment, the decomposition-resistant electrolyte layers 125 and 126 provided in the electrolyte layer 121 act as decomposition reaction suppress parts for suppressing decomposition of the electrolyte layer 121. Also, by providing the highly proton conductive electrolyte layer 127 made from solid oxide with a high proton conductivity between such decomposition-resistant electrolyte layers 125 and 126, proton conductivity of the entire electrolyte layer 121 is ensured. When forming the electrolyte layer 121, the thickness of each of the decomposition-resistant electrolyte layers 125 and 126 and of the highly proton conductive electrolyte layer 127 (the ratio to the overall thickness of the electrolyte layer 121) may be arbitrarily set, taking into account effects of hindering decomposition of the electrolyte layer 121 by providing the decoinposition-resistant electrolyte layers 125 and 126 and the balance with the proton conductivity of the overall electrolyte layer 21.

### C. Third Embodiment

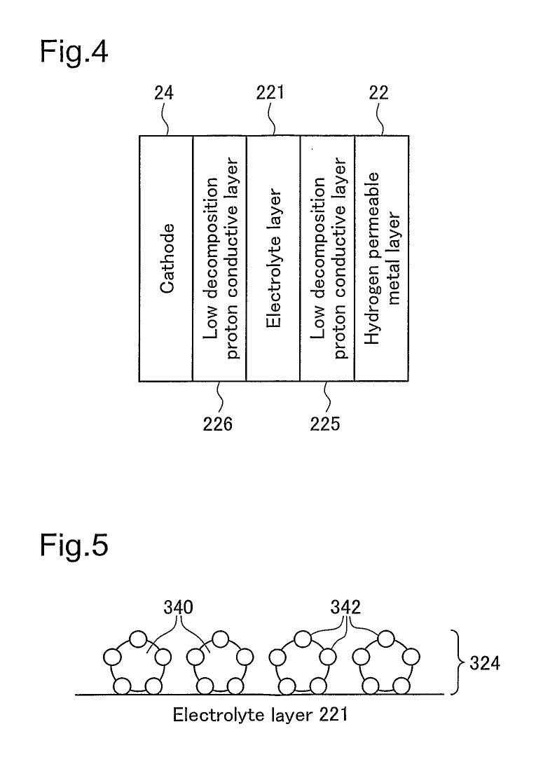

The construction of the fuel cell of the third embodiment is described with reference to FIG. 4. FIG. 4 is an explanatory view representing the construction of the fuel cell of the third embodiment. Other than the fuel cell of the third embodiment has low decomposition proton conductive layers 225 and 226 and an electrolyte layer 221 instead of the electrolyte layer 21, the fuel cell of the third embodiment has a configuration similar to that in the first embodiment, so parts in common are provided with the same reference numbers and a detailed description is omitted. As in FIG. 2 and FIG. 3, the hydrogen permeable metal layer 22, the cathode 24, and the layers disposed therebetween are shown.

As shown in FIG. 4, the low decomposition proton conductive layer 225, the electrolyte layer 221, the low decomposition proton conductive layer 226, and the cathode 24 are progressively layered on the hydrogen permeable metal layer 22 of Embodiment 3. In the present embodiment, the electrolyte layer 221 is formed with a ceramic proton conductor such as BaCeO₃, SrCeO₃, or the like, as with the electrolyte layer 21 of the first embodiment. Also, the low decomposition proton conductive layers 225 and 226 have proton conductivity, and are composed of a low decomposition material whose activity that decomposes the solid oxide composing the electrolyte layer 221 is lower than that in the hydrogen permeable metal layer 22 and the cathode 24. In the present embodiment, tungsten oxide (WO₃), a compound conductor having proton conductivity and electron conductivity, is used as a low decomposition material composing the low composition proton conductivity layers 225 and 226. The low decomposition proton conductivity layers 225 and 226 made from tungsten oxide can be formed with, for example, an impregnation method. In further detail, after a tungsten solution, for example, paratungstate aqueous solution ((NH₄)₁₀[W₁₂O₄₂H₂].10H₂O), is impregnated, it is calcinated, and the impregnated tungsten is oxidized to form the low decomposition proton conductive layers 225 and 226 on the surface for forming those layers. Alternatively, the low decomposition proton conductive layers 225 and 226 may be formed with a method other than impregnation such as PVD or CVD.

In such a fuel cell, a proton that passes through the hydrogen permeable metal layer 22 is supplied to the electrolyte layer 221 through the low decomposition proton conductive layer 225, passes through, then passes through the low decomposition proton conductive layer 226, and is provided for a reaction with oxygen in the cathode 24.

According to the fuel cell of the third embodiment with a construction as above, low decomposition proton conductive layers are formed on both surfaces of the electrolyte layer 221, so it is possible to suppress decomposition of the electrolyte layer 221 and prevent a drop in performance of the fuel cell. In further detail, in the present embodiment, the low decomposition proton conductive layers 225 and 226 provided between the electrolyte layer 221, and the hydrogen permeable metal layer 22 and the cathode 24 respectively act as decomposition reaction suppress parts to suppress decomposition of the electrolyte layer 221. In addition to being composed of low decomposition material with lower activity that decomposes the solid oxide composing the electrolyte layer 221 than that of the catalytic metal composing the hydrogen permeable metal layer 22 and the cathode 24, the low composition proton conductive layers 225 and 226 can be said to be composed of decomposition-resistant material whose decomposition reactivity for decomposing due to the catalytic metal is lower than that of the electrolyte layer 221.

In the third embodiment described above, a metal oxide is used as a low decomposition material composing the low composition proton conductive layers 225 and 226, but other metals having proton conductivity may be used as well. For example, titanium (Ti), magnesium (Mg), or an alloy of Ti and Mg, or another metal known as a hydrogen occlusion metal may be used. It is possible to pass hydrogen in an atomic or ionic state and pass a proton to the electrolyte layer 221, and if the low decomposition material has lower activity that decomposes the electrolyte layer 221 than the noble metal that composes the electrode or hydrogen permeable metal layer, the low decomposition proton conductive layers 225 and 226 can be formed similarly.

### D. Fourth Embodiment

In the first to third embodiments described above, the cathode 24 is formed as a thin metal membrane provided on a decomposition reaction suppress part formed in a layer, but different structures are also possible. A structure for forming a cathode from metal grains, a part of whose surface is covered by the decomposition reaction suppress part, is described below as Embodiment 4.

The construction of the fuel cell of the fourth embodiment is described with reference to FIG. 5. FIG. 5 is an explanatory view representing the construction of the fuel cell of the fourth embodiment. In FIG. 5, only the structure near the cathode is shown. Other parts composing the fuel cell have configurations similar to in the fuel cell of First embodiment, though there is no problem with using a structure similar to that in the fuel cell of the second embodiment or third embodiment. A cathode 324 provided in the fuel cell of the fourth embodiment is formed on the electrolyte layer similar to the electrolyte layer 221 of the third embodiment. The cathode 324 is formed by causing grains, which are catalytic metal grains (hereinafter referred to as electrode grains 340) having catalytic activity to promote electrochemical reactions, which disperse in a support function fine shielding grains 342 made from a low decomposition material having proton conductivity in the grain surface, to disperse in a support formation on the electrolyte layer 221. In the present embodiment, Pt is used as a catalytic metal for forming electrode grains 340, and tungsten oxide is used similar to in the third embodiment as a low decomposition material for composing the fine shielding grains 342.

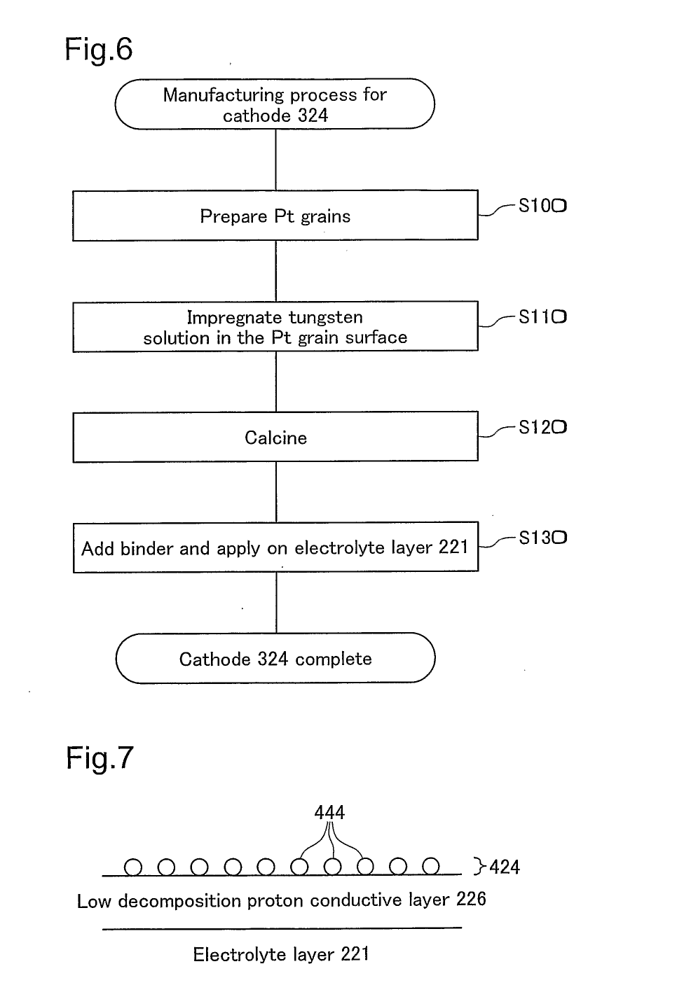

The manufacturing method of the cathode 324 is described with reference to FIG. 6. FIG. 6 is an explanatory view showing the manufacturing process for forming the cathode 324. When forming the cathode 324, first, Pt grains are prepared as the electrode grains 340 (step S100). At that time, the smaller the diameter of the Pt grains, the more the electrode surface that may come into contact with oxygen can be increased in the cathode 324. The diameter of the Pt grains can be made 0.1 to several μm, for example. Next, a solution containing tungsten is impregnated in the Pt grains prepared in step S100 (step S110). By calcining the Pt grains impregnated with the tungsten solution (step S120), the tungsten is oxidized, and Pt grains are obtained that provide dispersed support of tungsten oxide fine grains on the surface. The more the quantity of tungsten oxide that is dispersed in a support formation on the Pt grains, the more certain contact between the electrode grains 340 and the electrode layer 221 can be avoided, and the less the quantity of tungsten oxide that is supported, the larger the electrode area that may be ensured for coming into contact with oxygen during the production of electricity. The quantity of tungsten in solution impregnated on the Pt grains may be set arbitrarily, taking into account the fuel cell performance and the effects from preventing contact between the electrode grains 340 and the electrode layer 221. When Pt grains to provide dispersed support of the tungsten oxide fine grains on the surface are obtained, next, a binder is added to the tungsten oxide support Pt grains to convert them to a slurry, and this is applied on the electrolyte layer 221 (step S130), completing the cathode 324.

According to the fuel cell of the present embodiment having the cathode 324 configured as above mentioned, the cathode is formed with catalytic metal grains, and the fine shielding grains 342 provide dispersed support on the surface of the grains, so it is possible to suppress contact between the catalytic metal and the electrolyte layer 221. Thus, it is possible to suppress decomposition of the electrolyte layer 221 due to catalysts, preventing a drop in performance of the fuel cell. In further detail, in the present embodiment, the fine shielding grains 342 that are dispersed in a support formation in the surface of the electrode grains 340 and that are interposed between the electrode grains 340 and the electrolyte layer 221 when the electrode grains 340 are caused to provide dispersed support on the electrolyte layer 221 act as a decomposition reaction suppress part. Here, a low decomposition material having proton conductivity does not necessarily need to be dispersed in a support formation on the surface of the electrode grains 340; if it is interposed between the electrode grains 340 and the electrolyte layer 221 while a part of the surface of the electrode grains 340 is covered, similar effects can be obtained. When covering the electrode grains 340 with a prescribed amount of low decomposition material, it is desirable to make the grain diameter of the low decomposition material as small as possible and cause it to be dispersed in a support formation over the entire surface of the electrode grains 340. This makes it possible to improve the reliability of preventing contact between the electrolyte layer 221 and the catalytic metal, and makes it possible to adequately ensure a supply of oxygen to the catalytic metal during the production of electricity.

In the fuel cell of the present embodiment, the other types of low decomposition materials given in the third embodiment may be used as the material to compose the fine shielding grains 342 instead of tungsten oxide. Also, the decomposition-resistant electrolyte used in the second embodiment may be used. By blocking direct contact between the catalytic metal and the solid oxide forming the electrolyte layer 221 and interposing a material whose activity for decomposing solid oxide is lower than catalytic metal or a material whose decomposition reactivity for decomposing due to catalytic metal is lower than solid oxide, it is possible to prevent decomposition of the electrolyte layer 221. In the present embodiment, the fine shielding grains 342 are used for support on the catalytic metal grains using an impregnation method, but an ion exchange or other method may also be used depending on the material composing the fine shielding grains 342 and the catalytic metal used.

### E. Fifth Embodiment

A structure for dispersing catalytic metal grains in a support formation and forming a cathode on a reaction suppress part is described below as the fifth embodiment with reference to FIG. 7. FIG. 7 is an explanatory view representing the construction of the fuel cell of the fifth embodiment 5. In FIG. 7, only the structure near the cathode is shown. Other parts composing the fuel cell have structures similar to those in the fuel cell of the first embodiment, though there is no problem with using structures similar to those in the fuel cell of the second embodiment or the third embodiment. A cathode 424 provided in the fuel cell of the fifth embodiment is formed by dispersing electrode grains 444 made from catalytic metal having catalytic activity for promoting electrochemical reactions in a support formation on the low decomposition proton conductive layer 226 of the third embodiment provided on the electrolyte layer 221. In the present embodiment, Pt is used as a catalytic metal to form the electrode grains 444. The diameter of the Pt grains can be made, for example, 0.1 to several μm. To form such a cathode 42, Pt grains with the diameter may be prepared, a removable solvent added to the Pt grains in a later process to form a paste, and the produced paste applied to the low decomposition proton conductive layer 226. Even with such a structure, the effect of suppressing decomposition of the electrolyte layer may be obtained by blocking contact of the catalytic metal and the electrolyte layer with the low decomposition proton conductive layer 226.

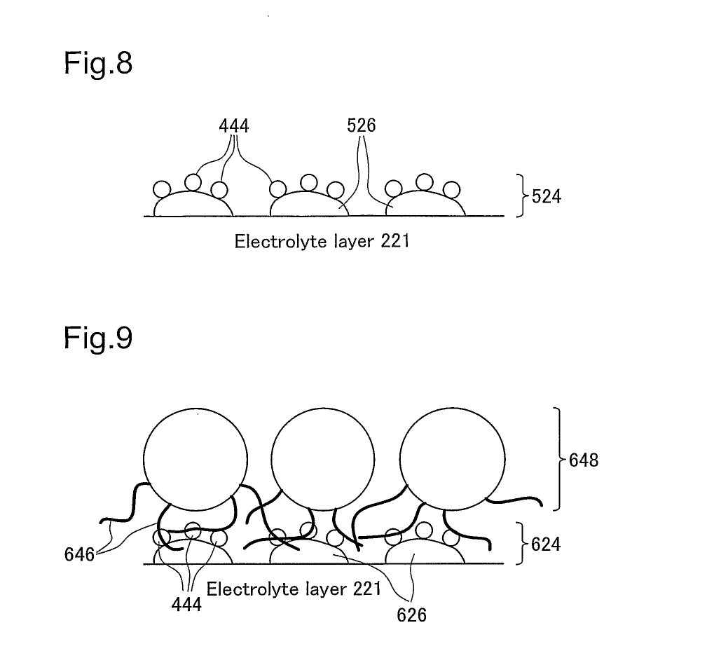

The structure of a cathode 524 provided in the fuel cell according to a first variant of the fifth embodiment is described with reference to FIG. 8. FIG. 8 is an explanatory view representing the structure of the cathode 524 provided in the fuel cell of the first variant of the fifth embodiment. The cathode 524 is provided on the electrode layer 221 as in the third embodiment. Also, the cathode 524 is formed by dispersing the electrode grains 444 in a support formation similar to in the fifth embodiment on a low decomposition proton conductive part 526 formed in a plurality of island forms separated from each other. The low decomposition proton conductive part 526 may be formed with a compound electric conductor similar to in the third embodiment. In forming the cathode 524, a photoresist may be applied beforehand to a region in which the island-form low decomposition proton conductive part 526 is not to be formed on the electrolyte layer 221, a layer of low decomposition proton conductive material similar to that in Embodiment 5 formed, and then Pt grains dispersed in a support formation on the low decomposition proton conductive layer, for example. Then, the cathode 524 in the desired form may be obtained by removing the photoresist. With such a structure, the effect of suppressing decomposition of the electrolyte layer can be obtained by blocking contact of the catalytic metal and the electrolyte layer with the low decomposition proton conductive part 526.

In the fifth embodiment and the first variant of the fifth embodiment, the electrode grains 444 are dispersed on the compound electric conductor in a support formation, but the electrode grains 444 may also be dispersed in a support formation on a decomposition-resistant electrolyte layer as in Embodiment 2. When doing so, the decomposition-resistant electrolyte may be formed in an island form similar to the low decomposition proton conductive layer 226 of the second embodiment, or may be formed in a plurality of island forms separated from each other similar to the low decomposition proton conductive part 526 in the first variant of the fifth embodiment.

The structure of a cathode 624 provided in the fuel cell according to the second variant of the fifth embodiment is described with reference to FIG. 9. FIG. 9 is an explanatory view representing the structure of the cathode 624, the second variant of the fifth embodiment. The cathode 624 is formed by dispersing the electrode grains 444 in a support formation on the decomposition-resistant electrolyte part 626 formed in a plurality of island forms separated from each other Such a cathode 624 can be produced with a method similar to that for the cathode 524. Even with such a structure, the effect of suppressing decomposition of the electrolyte layer may be obtained by blocking contact between the catalytic metal and the electrolyte layer with the decomposition-resistant electrolyte part 626.

If the reaction suppress part for dispersing the electrode grains 444 in a support formation does not have adequate electron conductivity as in the second variait of the fifth embodiment in which the decomposition-resistant electrolyte does not have electron conductivity, it is possible that electron transfer in the electrode grains 444 is inadequate during production of electricity in the fuel cell. In further detail, if electrode grains are dispersed in a support formation on a compound electric conductor, it is possible to transfer electrons to the electrode grains through the compound electric conductor, but if the electrode grains are dispersed in a support formation on a reaction suppress part with inadequate electron conductivity, it is possible that electrode grains will not be supplied with adequate electrons. Because of this, in the fuel cell provided with a cathode 624, a current collector 648 provided with minute electrically conductive fibers is provided adjacent to the cathode 624 as shown in FIG. 9. To form the current collector 648 with a carbon material, a carbon cloth, for example, a number of minute carbon fibers 646 of carbon nanotubes, or the like, may be provided attached to carbon fibers composing the carbon cloth. If a number of such minute carbon fibers 646 are provided, when the current collector 648 is provided such as to contact the cathode 624, the electrode grains 444 can contact any of the minute carbon fibers 646. Because of that, it is possible to transmit electrons supplied by the gas separator 29 (refer to FIG. 1) to the electrode grains 444 through the minute carbon fibers 646 or the carbon fibers composing the current collector 648, and it is possible to suppress contact resistance in the fuel cell.

### F. Variants

The invention is not limited to the embodiments and modes described above, but may be worked in a variety of modes with a scope that does not deviate from its main gist; the following sort of variants are possible, for example.

(1) A variety of variants are possible relating to the disposition of the reaction suppress part. In the first to third embodiments, similar reaction suppress parts were provided on both sides of the electrolyte layer, but different types of reaction suppress parts may be provided on the anode and cathode sides. Alternatively, as long as the decomposition reaction proceeds on either the anode side or the cathode side of the electrolyte layer within a tolerance range, the reaction suppress part may be provided only on the other side.

Also, a reaction suppress part may be provided in which the structure of the reaction suppress parts of the embodiments are combined. For example, a surface region with a grain boundary density higher than other regions may be formed in the electrolyte layer with a decomposition-resistant electrolyte layer whose decomposition reactivity for decomposition due to catalytic metal is lower than other regions, combining the first and second embodiments, for example.

(2) A variety of variants are possible relating to the structure of the electrode and the electrolyte layer in the fuel cell. With the fuel cells in the first to fifth embodiments, the electrolyte equipped with an electrolyte layer and a catalytic metal part having catalytic metal with activity for decomposing the electrolyte layer, the present invention may be applied. For example, instead of structures on the anode side and the cathode side, an anode electrode made from noble metal may be provided on the anode side and a hydrogen permeable metal layer on the cathode side. In this case as well, a decomposition reaction suppress part similar to in the present embodiment may be provided such as to prevent decomposition of the electrolyte layer because of the anode electrode and decomposition of the electrolyte layer because of the hydrogen permeable metal layer.

Alternatively, electrodes made from noble metal having catalytic activity may be provided as catalytic metal parts on both sides of the electrolyte layer made from a solid oxide without providing a hydrogen permeable metal layer. In this case as well, similar effects for preventing decomposition of the electrolyte layer may be obtained by providing a decomposition reaction suppress part similar to in the present embodiment.

The form of the catalytic metal part provided with catalytic metal can be varied even further. For example, it is possible to support noble metal catalysts in the surface on the side adjacent to the electrolyte layer to form an electrode that is a catalytic metal part on a conductive porous object having electric conductivity and gas permeability. In this case as well, a similar effect of preventing decomposition in the electrolyte layer can be obtained by providing a decomposition reaction suppress part similar to in the embodiments.

Also, the solid oxide for forming the electrolyte layer may be a proton conductive solid oxide other than a perovskite type; for example, a pyrochlore or spinel type may be used. Alternatively, even in a fuel cell not limited to proton conductive solid oxides, but that uses a solid oxide having oxide ion conductivity, the present invention may be applied.

1. A fuel cell comprising:
an electrolyte layer made from a solid oxide;
a catalytic metal part including a catalytic metal for accelerating a reaction of a reaction active material supplied to the fuel cell during generation of electricity in the fuel cell, wherein the catalytic metal is a noble metal; and
a decomposition reaction suppress part disposed between the electrolytic layer and the catalytic metal part for suppressing a decomposition reaction of the solid oxide due to the catalytic metal, wherein the decomposition reaction suppress part has ion conductivity for allowing ions of a same type of conductivity to pass through the electrolyte layer.

2. A fuel cell in accordance with claim 1, wherein
the decomposition reaction suppress part is constructed with a decomposition-resistant material that has lower decomposition reactivity for decomposing due to the catalytic metal than the solid oxide.

3. A fuel cell in accordance with claim 2, wherein
the decomposition reaction suppress part is formed in a layer form for covering the electrolyte layer surface with the decomposition-resistant material, and
the catalytic metal part is disposed on the decomposition reaction suppress part.

4. A fuel cell in accordance with claim 2, wherein
the catalytic metal part is formed with catalytic metal dispersed in a support formation in a granular state on the electrolyte layer, and
the decomposition reaction suppress part is formed with the decomposition-resistant material for covering a part of a granular surface of the catalytic metal such as to be interposed between grains of the catalytic metal and the electrolytic layer.

5. A fuel cell in accordance with claim 1, wherein
the decomposition reaction suppress part is formed with a low decomposition material that has lower activity for decomposing the solid oxide than the catalytic metal.

6. A fuel cell in accordance with claim 5, wherein the low decomposition material also has conductivity.

7. A fuel cell in accordance with claim 1, wherein
the decomposition reaction suppress part is formed in a layer form to cover the electrolyte layer surface with the low decomposition material, and
the catalytic metal part is disposed on the decomposition reaction suppress part.

8. A fuel cell in accordance with claim 1, wherein
the catalytic metal part is formed with catalytic metal dispersed in a support formation in a granular form on the electrolyte layer, and
the decomposition reaction suppress part is formed with the low decomposition material for covering a part of a grain surface of the catalytic metal such as to be interposed between grains of the catalytic metal and the electrolyte layer.

9. A fuel cell comprising:
a catalytic metal part including a catalytic metal for accelerating a reaction of a reaction active material supplied to the fuel cell during the production of electricity in the fuel cell, wherein the catalytic metal is a noble metal; and
an electrolyte layer formed with a solid oxide, disposed adjacent to the catalytic metal part, and having a decomposition reaction suppress part for suppressing a decomposition reaction of the solid oxide due to the catalytic metal.

10. A fuel cell in accordance with claim 9, wherein
the decomposition reaction suppress part is a region that is formed near a surface on a side of the electrolyte layer adjacent to the catalytic metal part, and that has a lower grain boundary density of the solid oxide other than the regions in the electrolyte layer.

11. A fuel cell in accordance with claim 9, wherein
the decomposition reaction suppress part is a region that is formed near a surface on a side of the electrolyte layer adjacent to the catalytic metal part, and
the solid oxide has lower decomposition reactivity for decomposition due to the catalytic metal than other regions in the electrolyte layer.

12. A fuel cell in accordance with claim 11, wherein the solid oxide for forming the decomposition reaction suppress part has lower in ion conductivity than the solid oxide for forming the other regions.

13. A fuel cell in accordance with claim 1, wherein
the solid oxide has proton conductivity,
the catalytic metal is a hydrogen permeable metal, and
the catalytic metal part is a fine hydrogen permeable metal layer for covering the decomposition reaction suppress part disposed on the electrolyte layer.

14. A fuel cell in accordance with claim 9, wherein
the solid oxide has proton conductivity,
the catalytic metal is a hydrogen permeable metal, and
the catalytic metal part is a fine hydrogen permeable metal layer for covering the decomposition reaction suppress part disposed on the electrolyte layer.
